(19) United States
(12) Patent Application Publication
(10) Pub. No.: US 2012/0212345 A1
(43) Pub. Date: Aug. 23, 2012

(54) DEVICE FOR THE TREATMENT OF SLEEP-RELATED CONDITIONS

(76) Inventor: Polly Harman, Wilmington, NC (US)

(21) Appl. No.: 13/400,568

(22) Filed: Feb. 20, 2012

Related U.S. Application Data
(60) Provisional application No. 61/444,596, filed on Feb. 18, 2011.
(60) Provisional application No. 61/467,173, filed on Mar. 24, 2011.

(51) Int. Cl. G08B 23/00

(52) U.S. Cl. 340/575

(57) ABSTRACT

A device and related methods are provided. The device may be for the treatment and detection of various medical and non-medical conditions, including for detecting and treating snoring and sleep apnea, for detecting rapid eye movement of a sleeping person, and for detecting drowsiness or sleepiness of a person. The device may include an alert indicator for providing alerts to the person and a sensor configured for sensing one or more conditions of the person and communicating the condition to the alert indicator.

### CROSS-REFERENCE TO RELATED APPLICATIONS

This application claims priority to U.S. Provisional Patent Application Nos. 61/444,596 filed on Feb. 18, 2011, and 61/467,173 filed on Mar. 24, 2011, the entire contents of which are hereby incorporated by reference.

### TECHNICAL FIELD

This application is directed towards a device for the treatment and detection of various medical and non-medical conditions, including for detecting and treating snoring and sleep apnea, for detecting the onset of drowsiness or dozing in a person, and for detecting and monitoring sleep conditions.

### BACKGROUND

Snoring is common among many humans. During snoring, a sound is produced while breathing during sleep. Snoring may be caused by the vibration of the soft palate and uvula, and, if left untreated, may lead to sleep apnea in which a person can experience abnormally shallow breathing during sleep. Sleep apnea can lead to daytime sleepiness, fatigue, trouble concentrating, and other undesirable side effects.

Furthermore, snoring is a nuisance for persons sharing a bed or room with the snorer. One person's snoring may cause the other person sharing a room to also experience uncomfortable or restless sleep.

Snoring is caused by obstructed air movement while breathing. This is usually due to a blockage of the breathing passage, which is many times due to the person's tongue falling back into their throat while sleeping on their back. Accordingly, one manner to treat snoring is to condition the person to sleep on their side or face down. However, it has proven difficult to train persons to sleep in a certain position.

Additionally, sleep apnea is a sleeping disorder in which a person has abnormal pauses in breathing or instances of abnormally shallow breathing during sleep. Much like snoring, sleep apnea is associated with tissue obstruction during sleeping.

Efforts have been made to develop a device or manner of alleviating snoring and sleep apnea. However, these efforts have resulted in devices which were ineffective, aesthetically or orthopedically unpleasing, or uncomfortable for the person to wear. Furthermore, these efforts were not aimed at training the person to sleep in a position in which snoring and sleep apnea were unlikely to occur. Accordingly, a need remains for a device that is effective in training a person to sleep in a position in which the person is not likely to snore or to suffer from sleep apnea, a device that is aesthetically pleasing, and a device that is comfortable for the person to wear.

Similarly, further efforts have been made to develop a device that can monitor a person's sleeping patterns. Such devices have not been able to monitor rapid eye movement (REM) associated with REM sleep, while working in conjunction with a device that can monitor snoring and other sleep-related conditions of a person. REM sleep is a stage of sleep that is characterized by random movement of the eyes. REM sleep may include 90 to 120 minutes of sleep for a typical adult. Maintaining appropriate levels of REM sleep is important for human health, and the one or more devices and methods disclosed herein may be appropriate for determining and detecting REM sleep. Further improvements are needed for these types of devices.

### SUMMARY

This Summary is provided to introduce a selection of concepts in a simplified form that are further described below in the Detailed Description of Illustrative Embodiments. This Summary is not intended to identify key features or essential features of the claimed subject matter, nor is it intended to be used to limit the scope of the claimed subject matter.

Disclosed herein is a device used for medical, commercial, and consumer applications that includes an alert indicator configured for being received about an ear of a person and for providing alerts to the person, a sensor configured for sensing snoring of the person, and a clip having a first end to which the alert indicator is carried and a second end to which the sensor is carried.

According to another embodiment, the alert indicator is deformable for conforming with the ear canal of the person.

According to another embodiment, the alert indicator emits an audible alert.

According to another embodiment, the alert indicator is configured to provide alerts when the sensor senses that the person is snoring.

According to another embodiment, the alert indicator emits an intermittent audible alert when the sensor senses that the person is snoring.

According to another embodiment, the alert indicator emits a constant audible alert when the sensor senses that the person is snoring

According to another embodiment, the sensor is configured for sensing snoring by sensing vibrations or frequencies emitted by soft tissue of the person.

According to another embodiment, the sensor is configured for sensing snoring by sensing vibrations of the soft tissue of the person into which the sensor is in contact with.

According to another embodiment, the sensor is configured for being placed below the ear and under the jawbone of the person.

According to another embodiment, the sensor is detachable from the clip so as to be replaceable.

According to another embodiment, the sensor is provided for contact with the person through use of an adhesive.

According to another embodiment, the adhesive is a pressure sensitive adhesive.

According to another embodiment, the adhesive is a medical grade adhesive.

According to another embodiment, the clip is current carrying and carries current to allow for communication between the sensor and the alert indicator.

According to another embodiment, the clip is resilient and deformable so as to be positioned as desired by the person.

According to another embodiment, the sensor and alert indicator are in wireless communication with one another.

According to another embodiment, a method of monitoring a person during sleeping is provided. The method includes detecting snoring of the person, and providing an alert to the person's ear canal in response to detection of snoring.

According to another embodiment, detecting snoring of the person includes detecting vibrations and their corresponding frequencies about a position below the person's ear and under the person's jaw bone indicative of snoring.

According to another embodiment, providing an alert comprises emitting an audible alert when snoring is detected.

According to another embodiment, a device is provided that includes an alert indicator configured for being received in an ear canal of a person and for providing alerts to the person and a sensor in wireless communication with the alert indicator and configured for sensing snoring of the person.

According to another embodiment, a device is provided that includes an alert indicator configured for being received about an ear of a person and for providing alerts to the person. The device includes a sensor configured for sensing the absence of breathing or periods of abnormally shallow breathing of the person. A clip is provided and has a first end to which the alert indicator is carried and a second end to which the sensor is carried. The alert indicator is configured to provide an alert to the person in response to the sensor sensing the absence of breathing or periods of abnormally shallow breathing of the person.

According to another embodiment, a device is provided. The device includes an alert indicator configured for being received in an ear canal of a person and for providing alerts to the person. The device includes a sensor provided about a person's eye and configured for detecting eye movement indicative of a condition of the person. The alert indicator is configured to provide an alert to the person in response to the condition of the person.

According to another embodiment, a method is provided. The method includes detecting eye movement of a person using a sensor positioned proximal at least one of the person's eye, monitoring the eye movement of the person, and determining a sleeping condition or pattern of the person based off of the monitored eye movement.

According to another embodiment, a method of monitoring a person is provided. The method includes detecting movement of the person's eyelids using a sensor that is configured for contacting the person, determining whether movement of the person's eyelids is indicative of sleepiness by comparing the detected movement to a predetermined value, and providing an alert to the person in response to determining movement indicative of sleepiness thereof.

According to another embodiment, determining whether movement of the person's eyelids is indicative of sleepiness includes determining a frequency of movements of the person's eyelids.

According to another embodiment, detecting movement of the person's eyelids comprises using a sensor that is proximal to the person's eye.

According to another embodiment, detecting movement of the person's eyelids includes detecting up and down movement thereof.

According to another embodiment, providing an alert to the person includes providing an audible alert to the person's ear.

According to another embodiment, detecting movement of the person's eyes includes detecting movement of each of the person's eyes.

According to another embodiment, a method is provided that includes detecting movement of the mechanisms of eye movement of the person using a sensor that is configured for contacting the person and determining whether movement of mechanisms of eye movement is indicative of rapid eye movement (REM) by comparing the detected movement to a predetermined value.

According to another embodiment, determining whether movement of mechanisms of eye movement is indicative of REM includes determining a frequency of movements of the mechanisms of eye movement.

According to another embodiment, detecting movement of mechanisms of eye movement includes using a sensor that is proximal to the person's eye.

According to another embodiment, detecting movement of mechanisms of eye movement includes detecting up and down or side-to-side movement thereof.

According to another embodiment, detecting movement of mechanisms of eye movement includes detecting movement at each of the person's eyes.

According to another embodiment, a method of monitoring a person during sleeping is provided. The method includes detecting movement of the soft tissue below the person's jawbone using a sensor that is configured for contacting the soft tissue and determining whether movement of the soft tissue is indicative of snoring by the person. The method may include providing an alert to the person in response to determining snoring thereby.

According to another embodiment, determining whether movement of the soft tissue is indicative of snoring includes determining a frequency of measured movements.

According to another embodiment, providing an alert to the person includes providing one of an audible alert, visual alert, contact alert, or combinations thereof.

According to another embodiment, the method includes detecting movement of mechanisms of eye movement using a sensor that is configured for contacting the person at a position about the person's eyes, and determining whether movement of mechanisms of eye movement is indicative of rapid eye movement (REM) by comparing the detected movement to a predetermined value.

According to another embodiment, determining whether movement of mechanisms of eye movement is indicative of REM includes determining a frequency of movements of the person's eyes.

According to another embodiment, detecting movement of mechanisms of eye movement includes detecting movement of the person's eyes.

According to another embodiment, detecting movement of mechanisms of eye movement includes detecting up and down or side-to-side movement thereof.

According to another embodiment, detecting movement of mechanisms of eye movement includes detecting movement at each of the person's eyes.

According to another embodiment, detecting movement of the soft tissue using a sensor includes using a sensor that is adhered to the soft tissue, providing an audible alert to the person includes using a device positioned in the person's ear canal that is configured for emitting the audible alert, and the sensor and the device are in wireless communication.

According to another embodiment, the sensor is further configured to detect sounds and determine whether the sounds are indicative of snoring by the person.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings exemplary embodiments; however, the presently disclosed invention is not limited to the specific methods and instrumentalities disclosed. In the drawings:

FIG. 1 is a side view of a device useful for treating one or more medical or non-medical conditions of a person according to one or more embodiments of the disclosed subject matter;

FIG. 2 is a side view of the device installed about a person, and further showing anatomical features of the person that are to interact with the device according to one or more embodiments of the disclosed subject matter;

FIG. 3 is a side view of the device installed about a person according to one or more embodiments of the disclosed subject matter;

FIG. 4 is a front view of the device installed about a person's ear, the view of the person's ear being shown in broken lines as a sectional view according to one or more embodiments of the disclosed subject matter;

FIG. 5 is a side view of a device installed about a person according to one or more embodiments of the disclosed subject matter;

FIG. 6 is a side view of a device according to one or more embodiments of the disclosed subject matter;

FIG. 7 is a side view of a device installed about a person's ear according to one or more embodiments of the disclosed subject matter;

FIG. 8 is a side view of a device for use for detecting rapid eye movement of a person. One or more sensors may be provided proximal the person's eyes on opposing sides of the person's face;

FIG. 9 is a side view of a device for use according to one or more embodiments disclosed herein;

FIG. 10 is a flow chart depicting a method according to one or more embodiments disclosed herein;

FIG. 11 is a flow chart depicting a method according to one or more embodiments disclosed herein; and

FIG. 12 is a flow chart depicting a method according to one or more embodiments disclosed herein.

### DETAILED DESCRIPTION

The presently disclosed invention is described with specificity to meet statutory requirements. However, the description itself is not intended to limit the scope of this patent. Rather, the inventor(s) have contemplated that the claimed invention might also be embodied in other ways, to include different elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

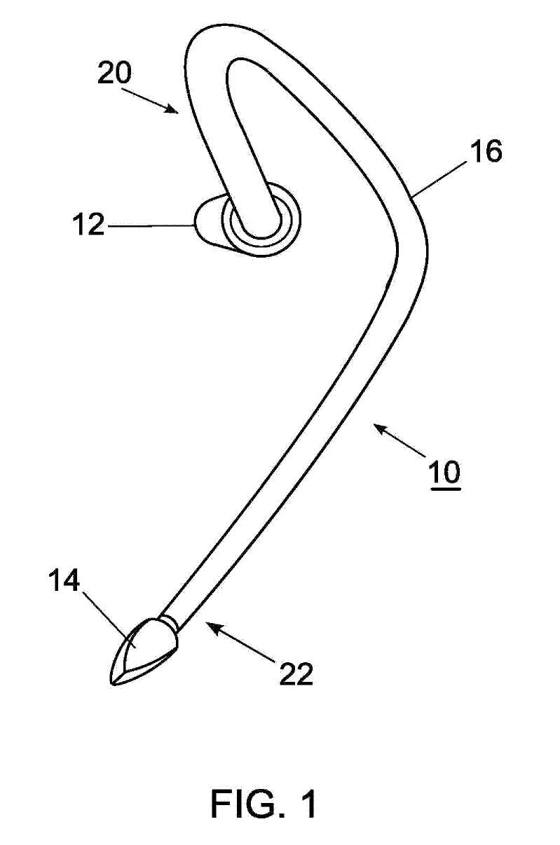

FIG. 1 illustrates a device generally depicted throughout the drawings as 10. The device is providing for detecting and monitoring one or more medical and non-medical conditions of a person. The device 10 includes an alert indicator 12 configured for being received about the ear, including in proximity to the ear, attached or otherwise engaged with the ear, or within the ear canal of a person. The alert indicator 12 may be for providing alerts to the person. The device 10 includes a sensor 14 configured for sensing snoring of the person. A clip 16 is provided that has a first end 20 to which the alert indicator 12 is carried and a second end 22 to which the sensor 14 is carried.

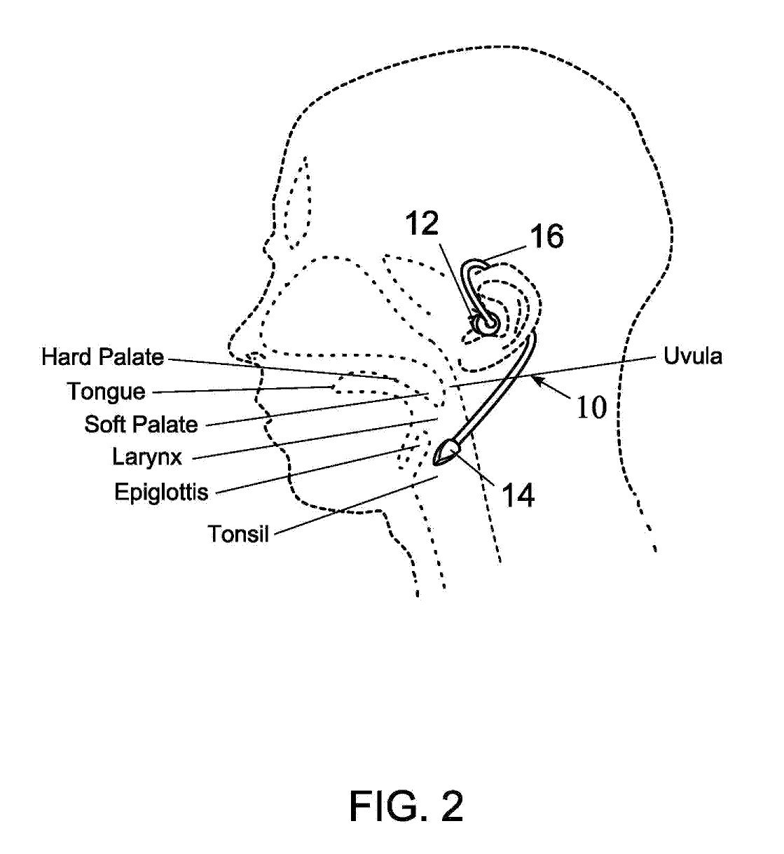

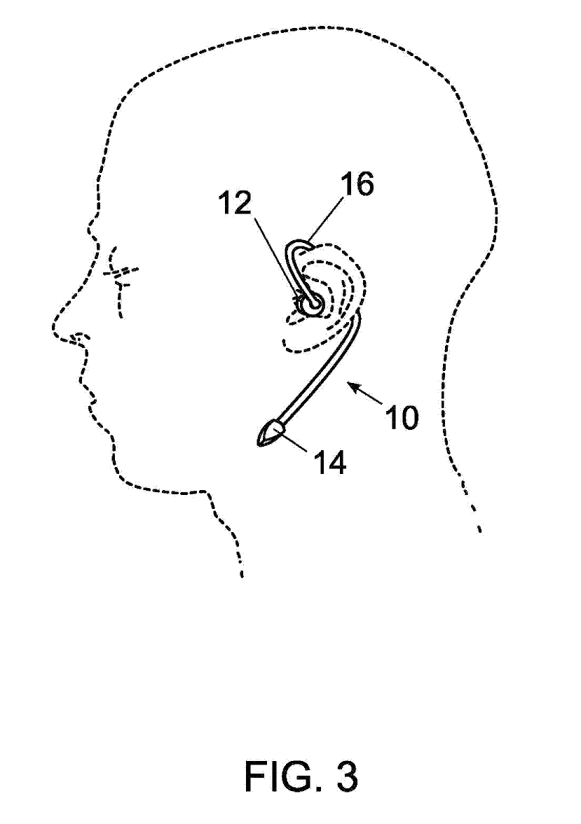

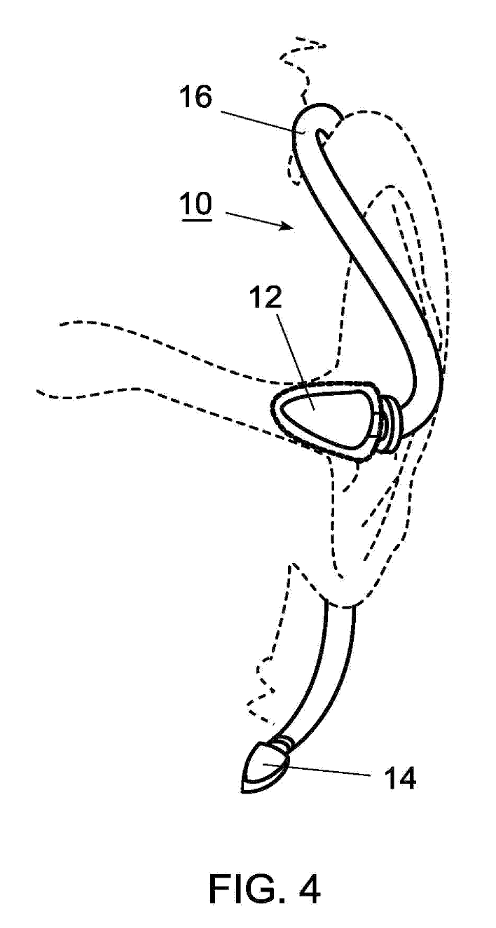

The device 10 is configured for being installed on a person as illustrated in FIGS. 2 through 4. As illustrated in FIG. 2, the device 10 is configured for being installed about an ear lobe of a person. The alert indicator 12 is provided for insertion into the outer ear canal of the person as more closely illustrated in FIG. 4. The clip 16 may be resilient and deformable so as to be deformed and positioned as desired by the person 1. In one or more embodiments illustrated herein, the clip 16 is deformable such that the clip 16 can be positioned about the person's ear lobe and the sensor 14 can be positioned about the soft tissue below the ear and under the jawbone of the person. In this manner, the sensor 14 will be provided in relation to soft tissue that is interconnected with and in proximity to the epiglottis, tonsils, uvula, and larynx. During snoring, caused by, for example, the person's tongue falling back into the person's throat while the person is sleeping on their back, air flow through the blocked air passage would cause a vibration about the soft tissue. The sensor 14 may be configured to sense this vibration of the soft tissue. For example, sensor 14 may sense this vibration through the use of any suitable sensor such as a displacement sensor, velocity sensor, accelerometer, or piezoelectric sensors, and also through the use of piezoelectric materials. According to embodiments of the present invention, the sensor 14 may be configured to sense any suitable characteristic that is desired to monitor or detect. For example, the sensor 14 may be configured to additionally detect sounds associated with either snoring or breathing. In this manner, the sensor 14 may be configured to detect breathing, or the absence of breathing or the presence of abnormally shallow breathing, or one of these conditions in addition to sounds indicative of snoring. In the absence of breathing, the sensor 14 may detect an absence or presence of abnormally shallow breathing which may be indicative of a sleep apnea condition. The sensor 14 and alert indicator 12 may be in further communication such that the sensor 14 sends a signal to the alert indicator 12 to alert the person during a sleep apnea or other monitored condition.

A front view of the device 10 illustrated in FIG. 4 shows the alert indicator 12 being received in the person's ear canal. The alert indicator 12 is further configured to emit an audible alert such as a sound when the sensor 14 senses snoring of the person. The audible alert may be a high or low pitch sound of varying frequencies. Additionally, the alert indicator 12 may emit an intermittent audible alert when the sensor 14 senses snoring of the person, or may also emit a constant audible alert when the sensor 14 senses snoring of the person. The alert indicator 12 may also provide audible alerts that are recognizable to persons other than the person, or may provide audible alerts that are only to be heard by the person. In one or more embodiments described herein, the audible alerts are emitted in the direction of the person's ear canal and are of a volume intensity such that only the person can hear the audible alert. In this manner, a person sharing a bed with the person would not be bothered by the audible alert. The alert indicator 12 may take on many varying shapes and sizes, and may be provided with deformable characteristics so as to deform to fit comfortably within the person's ear canal.

In one or more embodiments, the sensor 14 is detachable from the clip 16 so as to be replaceable. In this manner, a replacement sensor 14 can be utilized each time that the person enters into a new sleeping period. For example, replacement sensors may be adhered to the person in a manner similar to adhering an electrocardiography (EKG) sensor to a person. This may be advantageous, for example, because the sensor 14 may be adhered to the person through the use of an adhesive or tape. The adhesive or tape must be sufficiently strong to adhere the sensor 14 to the person for a sleeping cycle, yet not so strong so as to cause discomfort to the person upon removal of the sensor 14. The adhesive may be a pressure sensitive adhesive. The adhesive may also be a medical grade adhesive.

The clip 16 may be current carrying so that it carries current to allow for communication between the alert indicator 12 and sensor 14. Or the alert indicator 12 and sensor 14 may be in wireless communication with one another. The alert indicator 12 and/or sensor 14 may be provided with appropriately configured computer programmable code and may further be provided with a processor and/or memory for storing and executing the computer programmable code. In this manner, the alert indicator 12 and/or sensor 14 may contain the computer programmable logistics that are configured for controlling device 10.

In accordance with one or more embodiments, the alert indicator 12 and/or sensor 14 may be in communication with an external computer device that contains appropriately configured computer programmable code and a processor and/or memory for storing and executing the computer programmable code. The computer programmable code may be provided for controlling the alert indicator 12 and sensor 14.

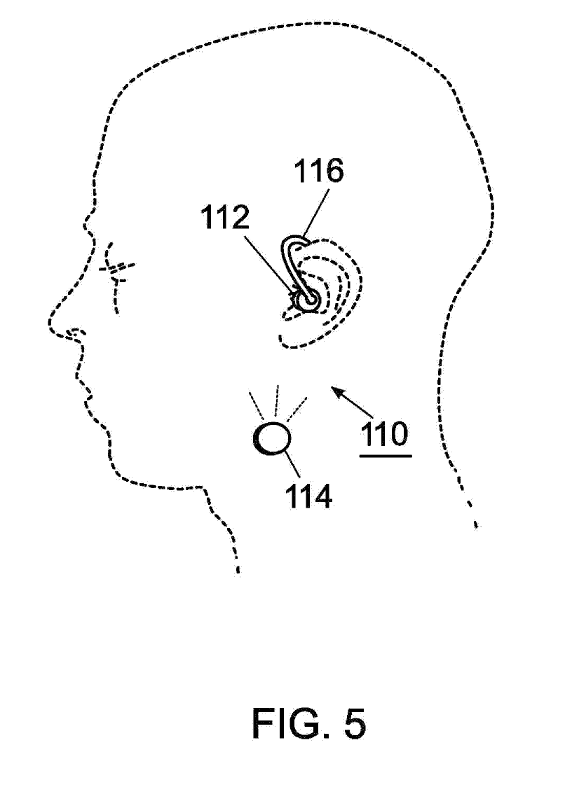

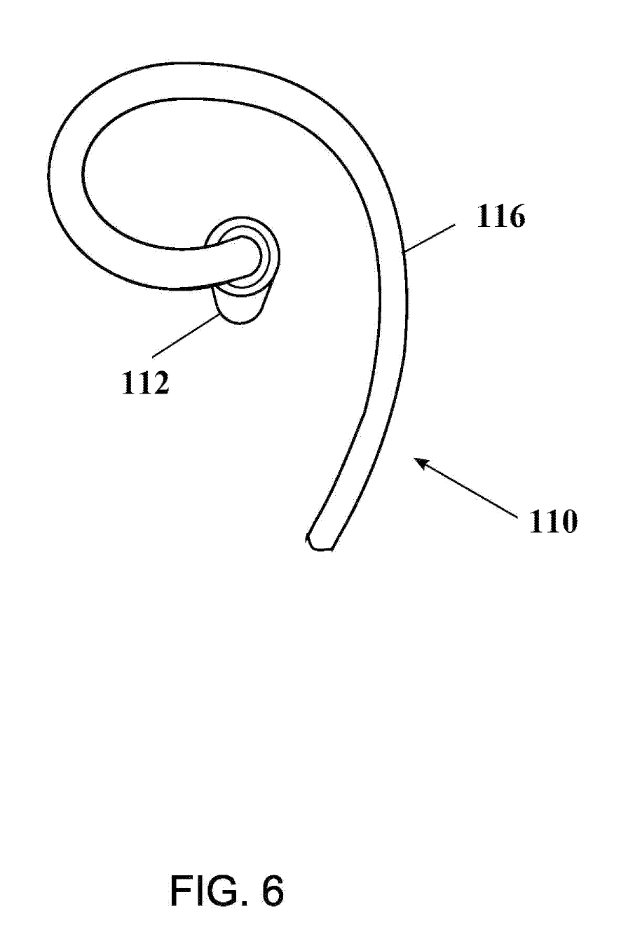

A device 110 is illustrated in FIGS. 5 and 6 that embodies many elements and characteristics of device 10. The device 110 includes an alert indicator 112 and a sensor 114 that is in wireless communication with the alert indicator 112. The sensor 114 is configured for being adhered to the person according to methods or manners disclosed herein. The sensor 114 is configured for detecting one or more conditions of the person, such as, for example, snoring by the person. The device 110 shown in FIG. 5 includes a clip 116 for resting about the person's ear.

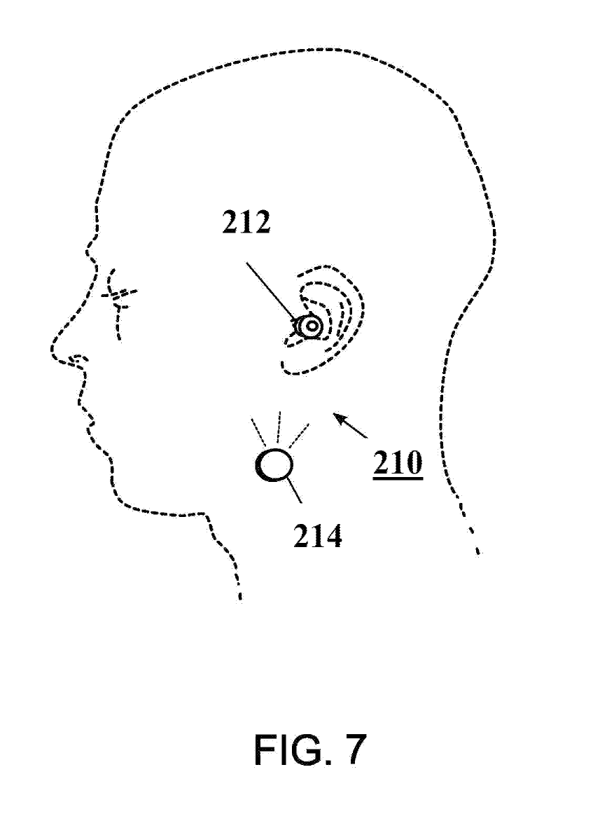

A device according to another embodiment is shown in FIG. 7 and depicted as 210. The device 210 includes an alert indicator 212 and a sensor 214 similar to the sensor that is described in FIG. 5. The device 210 shown in FIG. 7 is configured such that the alert indicator 212 is received in the person's ear without the use of a clip. In one or more embodiments, the alert indicator may be provided in proximity to the person's ear.

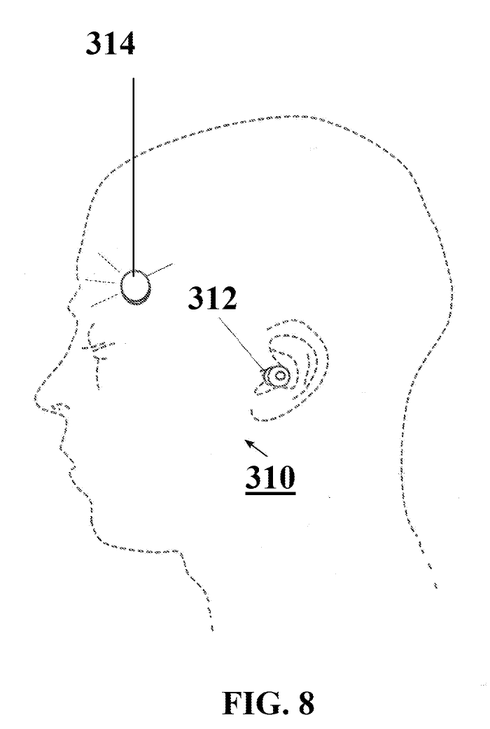

A device according to another embodiment is shown in FIG. 8 and depicted as 310. The device 310 includes an alert indicator 312 and a sensor 314. Sensor 314 is provided for being positioned proximal a person's eyes, and the device 310 may include two sensors 314 that are positioned on opposing sides proximal to each eye of a person. The sensors 314 may be provided for detecting rapid eye movement (REM). In instances in which two sensors 314 are employed, the sensors may work in unison to determine REM. As illustrated, sensors 314 are shown positioned above and rearward of the eyes, but may be positioned in many other locations, including proximal the upper or lower eyelid. The sensors 314 may also be configured for detecting the time period in which eye movement occurs, and, for example, may be configured to determine that movement of the eyes of a predetermined period of time is indicative of REM. The sensors 314 may then transmit data to the indicator 312, or alternatively, to an external server or similar for storing data and further manipulation to determine the need for desired interventions or treatments. The sensors 314 may include, for example, accelerometers that detect movement of the person's skin near the eyes that is indicative of movement. Additionally, the sensors 314 may be provided with appropriately configured piezoelectric characteristics or the like for determining eye movement. Other appropriately configured mechanisms for determining REM may also be employed.

In accordance with aspects of the invention, miniature piezo film sensors may be utilized as sensor 314. This sensor may be used as an external sensor such as that which is depicted in one or more Figures disclosed herein, or in one or more embodiments, may be implanted into the person's skin. Additionally, this sensor may be configured for detecting movement, and in some applications may be provided proximal a person's eye to detect mechanisms of eye movement. Positioned proximal a person's eye may include being in contact with the person's eye, eyelid, or tissue or muscle about the orbital bone. Sensor 314 may be configured for detecting the mechanisms of movement of the eye. In this manner, sensor 314 may be configured for detecting expansion and contraction of the skin or muscles near an eye, or movement and displacement of the skin or muscles near an eye. Additionally, in one or more embodiments, sensor 314 may be implanted or otherwise engaged with the eyelid or the eye of the person. For example, as a non-limiting example, sensor 314 may be contained within a lens, such as a contact lens, that is worn by the person. Sensor 314 may have many appropriate applications, including detecting of Rapid Eye Movement (REM) sleep. In one or more embodiments, such a sensor 314 utilized in conjunction with alert indicator may be used to detect and predict the onset of dozing, such as, for example, while driving or performing other tasks. In this manner, one aspect of the device may call for an alert device that alerts a user that they may be becoming drowsy. Sensor 314 may also be configured for detecting up and down movement of the eyelids. This movement may be indicative of sleepiness or drowsiness. In this manner, alert indicator 312 may be configured for providing an alert if it is determined that the person is sleepy or drowsy. The alert may be one of audio, visual, contact, and combinations thereof.

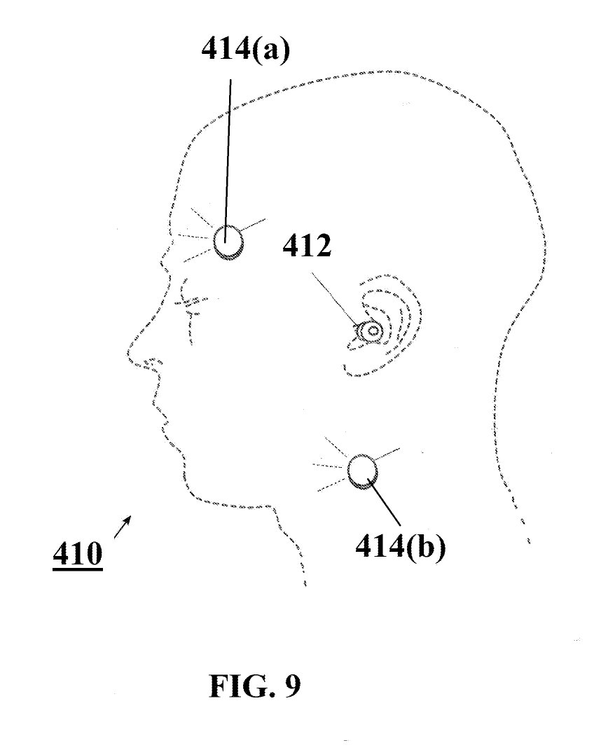

A device according to an alternate embodiment is shown in FIG. 9 and depicted as 410. The device 410 may include an indicator 412 that is in communication with a sensor 414(a) that is positioned proximal a person's eye similar to the sensor 314 shown in FIG. 8 and a sensor 414(b) that is positioned about the soft tissue of the person similar to sensor 114 in FIG. 5. Each of the sensors 414(a) and 414(b) may be in communication with one another and the indicator 412. Sensors 414(a) and 414(b) may work together to monitor one or more conditions of the person. Further processing of the monitored conditions by sensors 414(a) and 414(b) may provide additional data that may be indicative of a medical or non-medical state of the person.

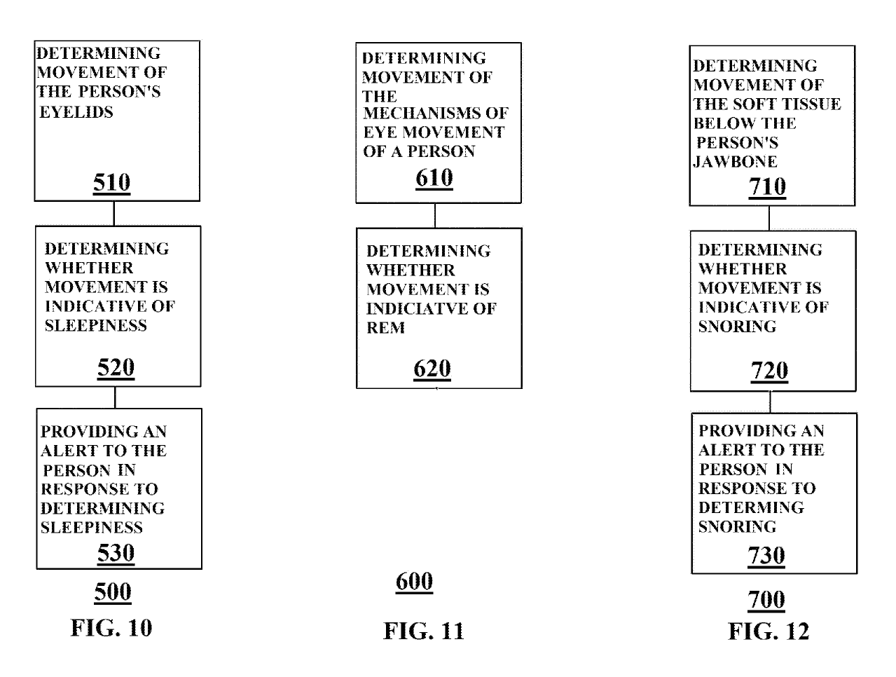

A flowchart illustrated in FIG. 10 illustrates general steps of monitoring a person to determine one or more conditions thereof. The method 500 includes detecting movement of the person's eyelids 510. This detection may employ any of the sensors disclosed herein. The sensors may include an accelerometer, a piezoelectric sensor, a magnetic sensor, or the like. The sensors may be configured for detecting up and down movement that may be indicative of blinking and side-to-side movement of the person's eyes that may be indicative of REM movement. The sensors may be positioned at each of the person's eyes, or just one of the person's eyes.

The method 500 may include determining whether movement is indicative of sleepiness 520. This determination may be made by determining whether movement is indicative of sleepiness by using any of the sensors disclosed herein. For example, this determination may be made by determining whether the movement is within a predetermined value associated with the condition that is being examined or alternatively outside of a predetermined value that is associated with that or some other condition. The sensors may be configured for determining whether movement of the person's eyelids occurs at a frequency that may occur with blinking associated with sleepiness. In this manner, when the sensors detect up and down movement of the eyelids at a certain frequency, the sensors may determine that this is likely indicative of sleepiness or the onset of dozing. Alternatively, the sensors may be configured to detect when the person's eyes are closed and thus indicating that the person is dosing.

The method 500 may include providing an alert to the person in response to determining sleepiness 530. This alert may be an audible, visual, or physical alert and may use any of the alert indicators disclosed herein.

A similar method is illustrated in the flowchart of FIG. 11 in which a method 600 is provided. The method 600 may include detecting movement of the mechanisms of eye movement of a person 610. This detection may employ any of the sensors disclosed herein. The sensors may include an accelerometer, a piezo electric sensor, a magnetic sensor, or the like. The sensors may be configured for detecting movement of the person's eyes similar to that which is described with reference to the one or more methods of FIG. 10. For example, this determination may be made by determining whether the movement is within a predetermined value associated with the condition that is being examined or alternatively outside of a predetermined value that is associated with that or some other condition. The sensors may be positioned at each of the person's eyes, or just one of the person's eyes.

The method 600 may include determining whether movement of the mechanisms of eye movement is indicative of REM sleep 620. REM sleep may be characterized by relatively quick, random movement of the eyes during sleeping. In this manner, the sensors may be configured for detecting quick, random movements in order to determine that REM sleep is occurring. The one or more devices and methods disclosed herein may be appropriate for monitoring a person to determine sleep cycles.

A flowchart illustrated in FIG. 12 illustrates general steps of monitoring a person to determine one or more conditions thereof. The method 700 includes detecting movement of the soft tissue below the person's jawbones 710. This detection may employ any of the sensors disclosed herein. The sensors may include an accelerometer, a piezoelectric sensor, a magnetic sensor, or the like.

The method 700 may include determining whether movement is indicative of snoring 720. This determination may be made by determining whether movement is indicative of snoring by using any of the sensors disclosed herein. The sensors may be configured for determining whether movement of the soft tissue occurs at a frequency or amplitude that may be associated with snoring. Determining snoring may include detecting vibrations of the soft tissue. In accordance with embodiments disclosed herein, methods for detecting sleep apnea of a person are also disclosed herein. The method may generally include detecting the absence of breathing by a person, and providing an alert to the person in response to detection of absence of breathing.

The method 700 may include providing an alert to the person in response to determining snoring 730. This alert may be an audible alert and may use any of the alert indicators disclosed herein.

The device 10 may be operational to train a person to sleep with the correct posture and in a correct position so as to eliminate snoring. For example, if a person is sleeping in a position in which they begin to snore, sensor 14 senses the state of snoring and alert indicator 12 then provides alerts to the person. As a non-limiting example thereof, the alert may be an audible signal. In this manner, the alert indicator 12 continues to emit an audible signal until the sensor 14 no longer senses snoring. This could be because the person has repositioned themselves in a sleeping position in which the person's airways are not restricted and therefore there is no snoring. Accordingly, the person will learn to sleep in a position in which they are not likely to snore.

In one or more embodiments, the sensors disclosed herein may be configured for monitoring more than one characteristic. For example, sensor 214 and sensor 414(b) may be further configured for monitoring a characteristic such as sound, electrical charges from contracting and expanding muscles, perspiration, and the like. In this manner, for example, sensor 214 may be configured for both detecting vibration or other movement of the soft tissue below the person's jawbone and for detecting, for example, sound emanating from the person. The sensor 214 may then compare one or more attributes of the additional characteristic to the detected vibration. For example, if sensor 214 senses movement of the soft tissue of a certain amplitude and frequency, and conversely senses a sound of a similar amplitude and frequency, this may further verify that snoring has been detected. Similarly, sensor 414(b) may be configured for monitoring one or more characteristics.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method of monitoring a person, the method comprising:
detecting movement of the person's eyelids using a sensor that is configured for contacting the person;
determining whether movement of the person's eyelids is indicative of sleepiness by comparing the detected movement to a predetermined value; and
providing an alert to the person in response to determining movement indicative of sleepiness thereof.

2. The method of claim 1, wherein determining whether movement of the person's eyelids is indicative of sleepiness comprises determining a frequency of movements of the person's eyelids.

3. The method of claim 1, wherein detecting movement of the person's eyelids comprises using a sensor that is proximal to the person's eye.

4. The method of claim 3, wherein detecting movement of the person's eyelids comprises detecting up and down movement thereof.

5. The method of claim 3, wherein providing an alert to the person comprises providing an audible alert to the person's ear.

6. The method of claim 1, wherein providing an alert to the person comprises providing one of an audible alert, visual alert, contact alert, or combinations thereof.

7. A method of monitoring a person, the method comprising:
detecting movement of the mechanisms of eye movement of the person using a sensor that is configured for contacting the person; and
determining whether movement of the mechanisms of eye movement is indicative of rapid eye movement (REM) by comparing the detected movement to a predetermined value.

8. The method of claim 7, wherein determining whether movement of the mechanisms of eye movement is indicative of REM comprises determining a frequency of movements of the mechanisms of eye movement.

9. The method of claim 7, wherein detecting movement of the mechanisms of eye movement comprises using a sensor that is proximal to the person's eye.

10. The method of claim 9, wherein detecting movement of the mechanisms of eye movement comprises detecting movement of the mechanisms of eye movement indicative of up and down movement of the eyes, side-to-side movement of the eyes, or combinations thereof.

11. The method of claim 9, wherein detecting movement of the mechanisms of eye movement comprises detecting movement of each of the person's eyes.

12. A method of monitoring a person during sleeping, comprising:
detecting movement of the soft tissue below the person's jawbone using a sensor that is configured for contacting the soft tissue; and
determining whether movement of the soft tissue is indicative of snoring by the person.

13. The method of claim 12, further comprising providing an alert to the person in response to determining snoring thereby.

14. The method of claim 12, wherein determining whether movement of the soft tissue is indicative of snoring comprises determining a frequency of measured movements.

15. The method of claim 12, further comprising:
detecting movement of the mechanisms of eye movement of the person using a sensor that is configured for contacting the person at a position about the person's eyes; and
determining whether movement of the mechanisms of eye movement is indicative of rapid eye movement (REM) by comparing the detected movement to a predetermined value.

16. The method of claim 15, wherein determining whether movement of the mechanisms of eye movement is indicative of REM comprises determining a frequency of movements of the mechanisms of eye movement.

17. The method of claim 16, wherein detecting movement of the mechanisms of eye movement comprises detecting movement of the mechanisms of eye movement indicative of up and down movement of the eyes, side-to-side movement of the eyes, or combinations thereof.

18. The method of claim 16, wherein detecting movement of the mechanisms of eye movement comprises detecting movement of each of the person's eyes.

19. The method of claim 13, wherein detecting movement of the soft tissue using a sensor comprises using a sensor that is adhered to the soft tissue,
wherein providing an alert to the person comprises using a device positioned about the person's ear that is configured for emitting the alert, and
further wherein the sensor and the device are in wireless communication.

20. The method of claim 19, wherein the sensor is further configured to detect one or more additional characteristics, and the method further comprises comparing the one or more additional characteristics to the detected movement of the soft tissue in order to detect snoring.
